(19) United States
(12) Patent Application Publication
(10) Pub. No.: US 2020/0116596 A1
(43) Pub. Date: Apr. 16, 2020

(54) APPARATUS AND METHOD OF SAMPLING FOOD

(71) Applicant: UTI Limited Partnership, Calgary (CA)

(72) Inventors: Orly YADID-PECHT, Calgary (CA); Nikhil VASTEREY, Calgary (CA); Martin MINTCHEV, Calgary (CA); Jonathan WONG, Calgary (CA)

(21) Appl. No.: 16/160,111

(22) Filed: Oct. 15, 2018

(51) Int. Cl. G01N 1/00; A47J 43/07

(52) U.S. Cl. CPC G01N 1/00; G01N 2001/2229; A47J 43/07

(57) ABSTRACT

An example of an apparatus and method for sampling food. The apparatus includes a sampling unit for collecting the food. The apparatus further includes a transfer unit connected to the sampling unit. In addition, the apparatus includes an extraction system and a valve disposed between the transfer chamber and the extraction chamber.

### FIELD

The present specification relates generally to an apparatus and method of sampling food, and more particularly to an apparatus and method of sampling food for further testing.

### BACKGROUND

Current methods of acquiring a food samples for testing are generally not simple and easy to accomplish. The sample collector ideally has minimum physical contact with the food sample of interest and uses instruments to reduce the likelihood of contamination. The instruments need to be cleaned, dried and ensured free of cross-contaminants. In most cases, sterile tools/devices such as utensils, tongs, and tweezers are used when collecting food samples for testing. In addition, persons conducting testing generally wear gloves during sampling.

Sample collection and preparation typically requires a combination of user actions to optimize sample collection directly from the point of interest. These actions involve manual steps that make it difficult to collect samples from multiple points over an area, such as a plate of food, without extensive manual effort. Some conventional sampling strategies in food inspection involve using a pelican-type sampling tool, hand scoops, double sleeved trier or the traditional Nobbe trier. The double sleeve trier and Nobbe trier use a pointed tube with openings along the length of the tube that allow for the sampling of food. The manual steps introduce potential for error as well as slow the whole process down. For example, some methods require manual action for accessory attachment or sample loading between each sample collection.

### SUMMARY

An apparatus having a disposable sampling cartridge for sampling food is provided. The apparatus can significantly improve the quality and quantity of sampled food per cartridge.

### BRIEF DESCRIPTION OF THE DRAWINGS

Reference will now be made, by way of example only, to the accompanying drawings in which:

FIG. 1 is a schematic diagram of an apparatus in a first configuration in accordance with an embodiment;

FIG. 2 is another schematic diagram of the apparatus in a second configuration in accordance with the embodiment of FIG. 1;

FIG. 3A is a schematic diagram of a unit of the apparatus in accordance with the embodiment of FIG. 1;

FIG. 3B is a cross section of the apparatus in accordance with the embodiment of FIG. 1;

FIG. 4 is a schematic diagram of a sampling unit in accordance with an embodiment;

FIG. 5A is a first cross section of an embodiment of the transfer unit and the extraction system in accordance with an embodiment;

FIG. 5B is a second cross section of an embodiment of the transfer unit and the extraction system in accordance with said embodiment;

FIG. 6A is a cross section the transfer unit and the extraction system in a first valve position;

FIG. 6B is a cross section the transfer unit and the extraction system in a second valve position;

FIG. 7 is another cross section the transfer unit and the extraction system;

FIG. 8 is a flowchart of an example method; and

FIG. 9 is a schematic diagram of a food sampling area in accordance with an embodiment.

### DETAILED DESCRIPTION OF THE EMBODIMENTS

In describing the components of the apparatus and alternative versions, or embodiments, of some of these components, the same reference number can be used for elements that are the same as, or similar to, elements described in other versions or embodiments. As used herein, any usage of terms that suggest an absolute orientation (e.g. “top”, “bottom”, “front”, “back”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

When collecting food samples, each sample is to be collected by means that preserve integrity and reduce potential for contamination. Anomalies in sample integrity can arise from an inability of a sample to represent the chemical properties of an entire food plate due to improper sampling. Accordingly, the sampled food is not to be disturbed from its container or plate, especially for allergen detection in food, prior to testing. In addition, the sampling apparatus is to collect an adequate amount of sample for sample processing and testing. The sampled food is also to be representative of the entire food plate. For example, a sampling of 5 g or 5 ml of food can be sufficient in some situations, after which 0.25 g is used for an extraction process and further processing.

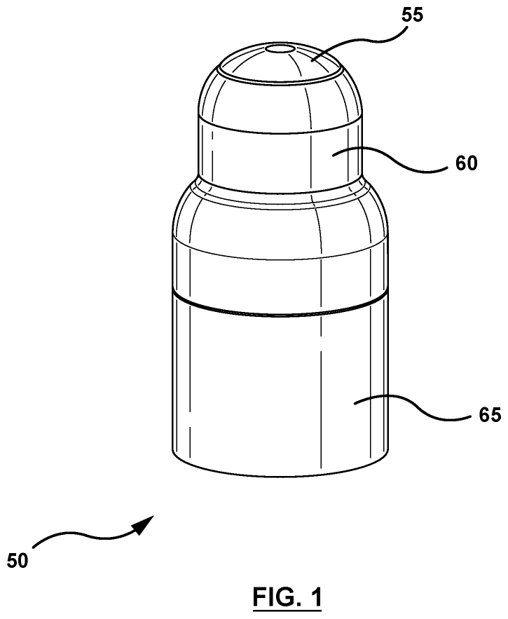

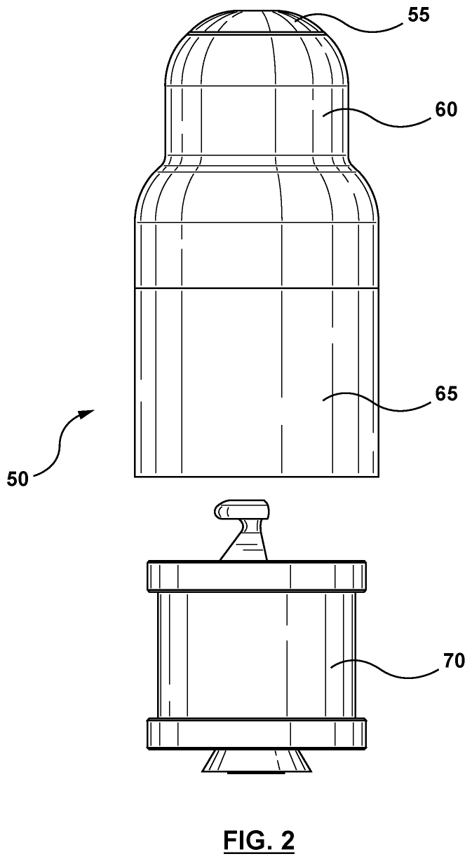

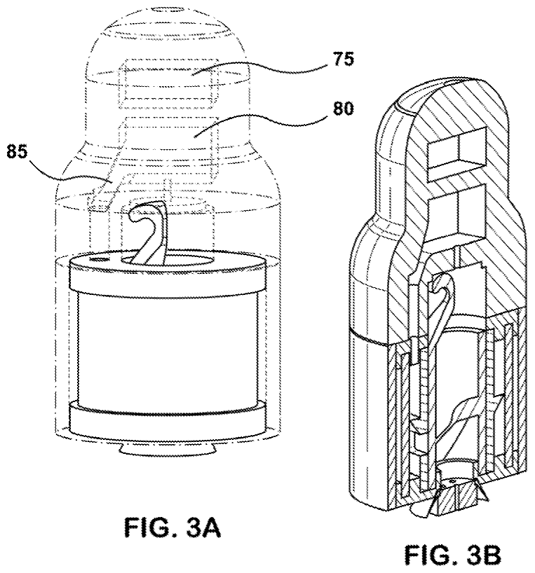

Referring to FIGS. 1, 2, 3A and 3B, a “point and collect” apparatus 50 is provided to mitigate the risk of invalid test results due to improper sample collection and preparation. The apparatus improves the integrity and the validity of the collected sample over conventional collection methods. In the present embodiment, the apparatus is sterile and portable. However, it is to be appreciated that in other embodiments, the apparatus may not necessarily be sterile. In further embodiments, the apparatus can also be a stationary device upon which a plate or container of food is placed for sample collection at multiple locations. Furthermore, the apparatus is generally configured to reduce the amount of manual intervention by a user to reduce the likelihood of accidental contamination. In the present embodiment, the apparatus 50 includes an activation button 55, an outer casing 60, and removeable component 65.

The activation button 55 is to activate the sample procedure. An internal PCB mounted within the outer casing will initiate the process.

The outer-casing 60 is the active component of the apparatus 50, and may be a permanent fixture used by a consumer. It is to be appreciated, as discussed in greater detail below, the other parts may be disposable, such as the unit 70. In addition, the apparatus 50 includes a PCB housing unit 75, a motor and/or vacuum pump housing area 80, and a communication port 85 for the vacuum.

Furthermore, the apparatus 50 includes a sampling unit 6, a transfer unit, and extraction system and a valve between the transfer unit and the extraction system.

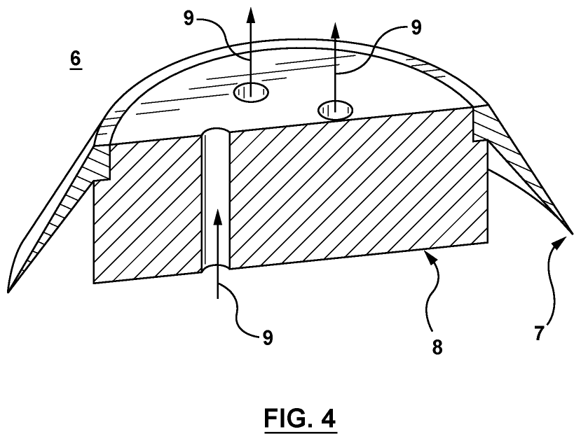

Referring to FIG. 4 a sampling unit 6 of the apparatus is generally shown. The sampling unit 6 is generally configured to collect food from a plate or container. It is to be appreciated by a person of skill in the art that the sampling unit 6 is not particularly limited and can include a wide variety of designs which may be based on the intended application. For example, different designs can be used for different types of food, such as liquid food, solid food, or a mixture of solid and liquid. In the present embodiment, the sampling unit is disposable or “one-time” use to reduce the likelihood of contamination. In other embodiments, the sampling head 6 can be sterilized after each use.

In the present embodiment, the sampling unit 6 is shaped like a cylindrical biopsy punch. The sampling head 6 includes a cutter 7, a grinder 8, and a plurality of passages 9 passing through the sample unit 6. The cutter 7 is not particularly limited and can include any type of cutting edge configured to cut food during sampling. For example, the cutter 7 can be a straight edge, a curved edge or include a serrated edge. The grinder 8 is also not particularly limited and can include any surface capable of grinding food. In particular, the grinder 8 is generally comprised of a hard material such as a hardened plastic. For example, the grinder 8 can be made from 3D printed acrylonitrile butadiene styrene or other suitable material. In other examples, the grinder 8 can be injection molded using various plastics, including recycled plastics. To facilitate with grinding, the grinder 8 may also include a roughened surface or an abrasive textured surface. The surface of the grinder 8 may also contain multiple pointed or sharp channeled protrusions to enhance the ability of the device to grip and separate a food sample from the source. In other embodiments, the grinder 8 can be modified to be an adhesive substrate to sample the food plate. In this embodiment, the adhesive substrate can function as both the sampling unit and an intermediate storage unit instead of having a separate transfer chamber 10.

The passages 9 are not particularly limited and are generally configured to allow a food sample to pass therethrough. For example, the passages 9 can be of any shape or size compatible with the samples to be collected. The passages 9 can be smaller for softer solid or liquid food. Conversely, if the food is expected to include larger solid pieces, the passages 9 can be larger to facilitate sample collection. Furthermore, in the present embodiment, the passages 9 are shown to be cylindrical to reduce the internal resistance of food passing therethrough. However, in other embodiments, the passages 9 can be formed with a different shape. In addition, the passages 9 also do not need to be straight and can be curved.

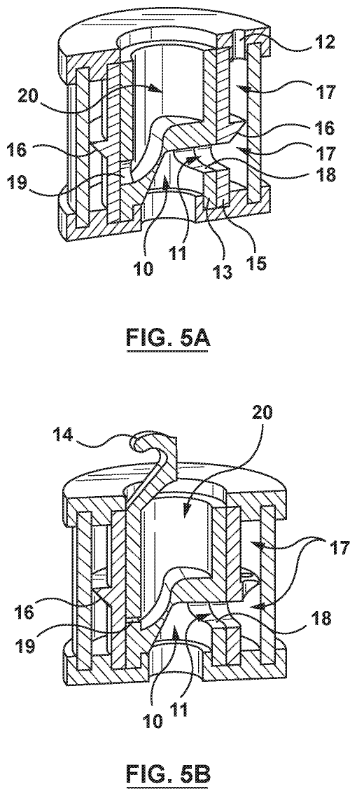

Referring to FIGS. 5A and 5B, the food sample is collected by the sampling unit 6 and passes through the passages 9 into a transfer unit having a transfer chamber 10. It is to be appreciated by a person of skill in the art that food samples entering the transfer chamber 10 will accumulate along the transfer chamber 10 and stack the food samples therein. In the present embodiment, the transfer chamber 10 is disposed over the sampling unit 6 such that it receives food is pushed up through the passages 9. The manner by which food is pushed up is not particularly limited. In this embodiment, the sampling unit 6 includes an optional vacuum source to facilitate collecting food. In the present embodiment, the vacuum source decreases the pressure in the transfer chamber 10 causing the external ambient pressure to push food up the passages 9 and into the transfer chamber 10. In the present embodiment, the vacuum source is a passage 12 connecting the extraction chamber 17 to an external vacuum (not shown). It is to be appreciated by a person of skill in the art that the vacuum is not particularly limited and can be omitted in some embodiments.

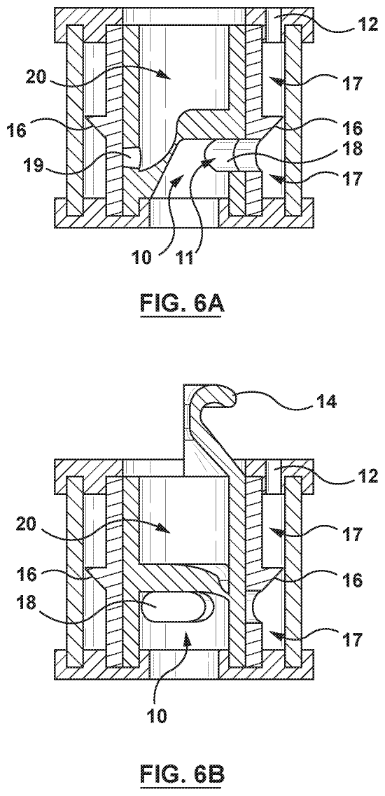

The transfer chamber 10 is further connected to an extraction unit having an extraction chamber 17. The extraction chamber 17 is configured to receive food samples from the transfer chamber 10. In addition, the transfer chamber 10 is separated from the extraction chamber 17 by a valve disposed therebetween. The valve is generally configured to control the flow of food between the transfer chamber 10 and the extraction chamber 17 by opening and closing. In the present embodiment, the valve includes a movable wall 13, and the stationary wall 15 as shown in FIG. 5A. The valve is controlled by rotating the inner wall 13 using the handle 14, such that the opening 11 can be opened or closed. In the open position, a flow of sampled food particles into the extraction chamber 17 is provided via the opening 11. In the closed position, the back flow of food particles from the extraction chamber 17 is reduced. It is to be appreciated by a person of skill in the art with the benefit of this description that the valve shown in FIGS. 6A and 6B also allows the sample collection process to be paused when the apparatus is moved between locations interest on the food plate.

As the food sample passes from the transfer chamber 10 to the extraction chamber 17 through the opening 11, the ledge 16 directs food particles away from traveling further into the upper part of the extraction chamber 17.

On completing the sample collection steps, the wall 13 is moved to a position that opens another opening 19 to the buffer chamber 20 containing an extraction buffer. It is to be appreciated that the buffer is not particularly limited. In the present embodiment, the buffer can be a water based salt solution, along with parts of alcohol to extract a target protein into an aqueous form. In particular, one example of a buffer solution can contain about 70% aqueous ethanol. In another example, the buffer may contain 40 mm of Sodium chloride aqueous solution in Phosphate buffer saline.

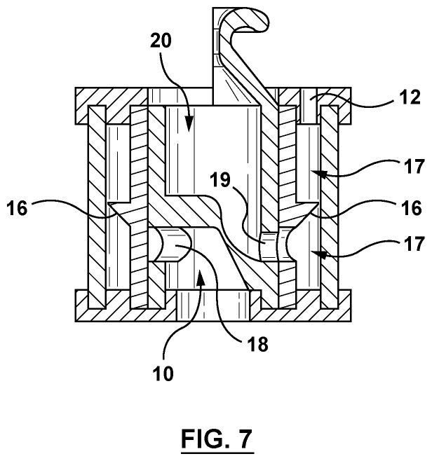

In this embodiment, the position of the wall 13 can also simultaneously close the opening 18 to the transfer chamber 10 as shown in FIG. 7. In the present embodiment, the extraction buffer flows down from chamber 20 to the extraction chamber 17 to initiate the sample extraction process. After the extraction buffer has emptied into the extraction chamber 17, the wall 13 is repositioned to the “closed” position to isolate the extraction chamber 17. After a period of time that completes the reaction between the extraction buffer and the food sample, the vacuum source connected to the passage 12 is activated to evacuate the contents of the extraction chamber 17 for further processing. As shown in FIG. 5A holes on the ledge 16 may obstruct the ascension of large solid particulates to protect the vacuum passage 12 from being clogged with the large solid particles.

It is to be appreciated by a person of skill in the art with the benefit of this description that variations are contemplated. For example, the apparatus can be a unitary body containing an integrated sampling unit, transfer unit, and extraction unit in a single housing. As another example, the apparatus can include a motorized element to open and close the valve that controls the flow of sampled food and extraction buffer. In this example, the motor can be used in place of the handle 14. Furthermore, the motor can also be used to power an agitator (not shown) to agitate the extraction buffer/food matrix to enhance the reaction. In addition, the motor can also be used to extract the processed sample, for example, through centrifugation or other mechanical means.

In use, the apparatus is configured to obtain multiple samplings of a food plate using generally three sub-units: a sampling unit, a transfer unit and an extraction system. The setting in which the apparatus is used is not particularly limited. For example, the plate of food may be one at a restaurant or one obtained from a retail store, wholesaler or an importer. In the present embodiment, the extraction system can also be used as a sample storage until the samples are removed from the apparatus for additional processing. It is to be appreciated by a person of skill in the art with the benefit of this description that one or more of the sub-units can be disposable “one-time” use to prevent cross-contamination between sampling events

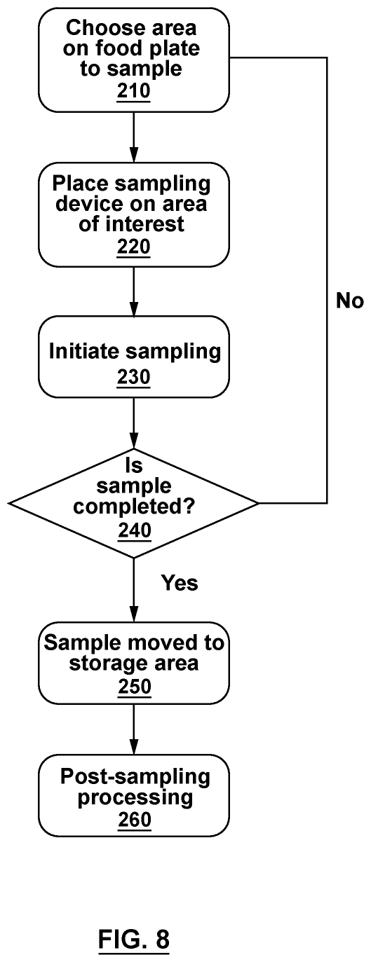

Referring to FIG. 8, a flowchart of a collecting a food sample is generally shown. In order to assist in the explanation of method, it will be assumed that method may be performed with the apparatus described above. Indeed, the method may be one way in which the apparatus may be configured and operated. Furthermore, the method may lead to a further understanding of the challenges, and the apparatus along with their various components.

Block 210 comprises choosing an area on a food plate from which a food sample is to be connected. The manner by which the area is selected is not limited and may involve an automated process or a manual process. Next, a sampling device may be placed on an area of interest (block 220) and a sampling process initiated (block 230). It is to be appreciated, that blocks 210 to 230 may be repeated until a determination is made at block 240 that the sampling process is completed. The manner by which this determination at block 240 is made is not limited. For example, the process may request a specified number of samples and each execution of block 240 may determine whether the specified number of samples has been achieved. Once the sample collection process is completed, the sample may be moved to a storage area (block 250) and subsequent sent for post-sampling processing at block 260.

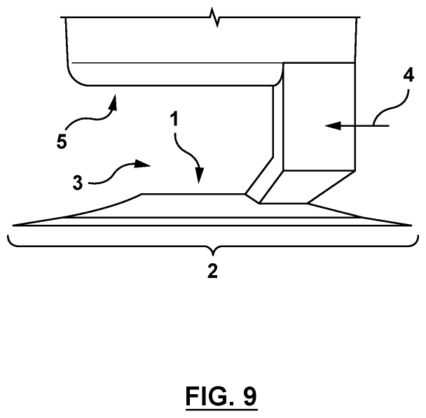

Referring to FIG. 9, a food sampling area is generally shown. In the present embodiment, the food sampling area can be an optional add-on component of the apparatus and includes a platform 2, a wall 4, and a housing 5. In the present embodiment, the platform 2 can be used to slide underneath a food sample of interest. As platform 2 is slid underneath the food sample of interest, the food sample will then enter the sampling area along the direction 3. The food sample is contained in the sampling area by the wall 4 that also acts as the connection between the sampling unit housing 5 and the sampling platform 2. The sampling unit 6 can then descend along the direction 1 from the sampling unit housing 5 onto the platform 2. The platform 2 can also behave as the backing support for the sampling action enabled by the sampling component 6.

It is to be appreciated by a person of skill in the art that the food sampling area is not particularly limited. For example, although the platform 2 is flat in the present embodiment, in other embodiments, the platform 2 can be shaped and have contours or be in the form of a scoop. In another embodiment, the platform 2 can have concentric through holes along the direction 1 which can limit the amount of food sampled along the horizontal direction. In yet another embodiment, the food sampling area can be omitted and the sampling head 6 can be applied directly on a plate of food.

The apparatus provides the ability to sample different portions of a food plate by passing the food sampling area over the region of interest. The food sampling area can also meter a set quantity of food onto the platform 2, thus collecting sizable and/or uniform portions suitable for subsequent processing.

While specific embodiments have been described and illustrated, such embodiments should be considered illustrative only and should not serve to limit the accompanying claims.

What is claimed is:

1. An apparatus for sampling food, the apparatus comprising:
a sampling unit for collecting the food;
a transfer unit connected to the sampling unit, wherein the transfer unit comprises a transfer chamber, the transfer chamber for receiving the food from the sampling unit;
an extraction system connected to the transfer unit, the extraction system comprising an extraction chamber, the extraction chamber for receiving the food from the transfer chamber; and
a valve disposed between the transfer chamber and the extraction chamber, the valve configured to control a flow of the food between the transfer chamber and the extraction chamber.

2. The apparatus of claim 1, wherein the sampling unit includes a vacuum source for collecting the food.

3. The apparatus of claim 2, wherein sampling unit includes a passage through which the vacuum source draws food.

4. The apparatus of claim 1, further comprising an agitator for mixing the food.

5. The apparatus of claim 4, wherein the agitator is powered by a motor.

6. The apparatus of claim 5, wherein the motor controls the valve. The apparatus of claim 1, wherein the sampling unit includes a cutter for cutting the food prior collecting the food.

8. The apparatus of claim 1, wherein the sampling unit includes a grinder for cutting the food prior collecting the food.

9. A method of collecting a food sample, the method comprising:
collecting a food sample with a sampling unit;
receiving the food sample from the sampling unit via a transfer chamber in a transfer unit, wherein the transfer unit is connected to the sampling unit;
receiving, into an extraction chamber connected to the transfer unit, the food sample from the transfer chamber; and
controlling a flow of the food between the transfer chamber and the extraction chamber with a valve disposed between the transfer chamber and the extraction chamber.

10. The method of claim 9, wherein collection the food sample comprises using a vacuum source for collecting the food sample.

11. The method of claim 10, wherein using the vacuum source comprises drawing the food sample through a passage.

12. The method of claim 9, further comprising mixing the food sample with an agitator.

13. The method of claim 12, further comprising powering the agitator with a motor.

14. The method of claim 13, further comprising controlling the valve with the motor.
